(19) United States
(12) Patent Application Publication
(10) Pub. No.: US 2007/0246143 A1
(43) Pub. Date: Oct. 25, 2007

(54) Mounted Assembly for Heavy Vehicles

(76) Inventor: Pierre Durif, Enval (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/597,193

(22) PCT Filed: May 13, 2005
(86) PCT No.: PCT/EP05/05276

§ 371 Date: Nov. 20, 2006

(30) Foreign Application Priority Data
May 19, 2004 (FR) 0405552

(51) Int. Cl. B60C 13/00

(52) U.S. Cl. 152/555

(57) ABSTRACT

The invention relates to a mounted assembly for heavy machinery, inflated to its rated pressure, constituted of a rim and a tire, the tire comprising a radial carcass reinforcement anchored to two beads, surmounted by a crown reinforcement which itself is surmounted by a tread joined to the beads by sidewalls, the rim being provided with two seats extended by rim hooks and intended to receive the beads of the tire. According to the invention, at least one device external to the tire and to the rim comes to bear, applying a pressure to at least one annular part of a sidewall, said device simultaneously bearing on a rim hook, the device being of toroidal form and defining an inner cavity. The invention also proposes a tire and a process for limiting the flexion of the sidewalls of a tire.

The present invention relates to a mounted assembly comprising a rim and a tire, intended to be fitted on a vehicle or item of heavy machinery of construction type, said tire comprising at least one carcass reinforcement radially surmounted by a tread.

The invention also relates to a tire and a process for limiting the flexion of the sidewalls of such a tire.

Although not limited to this type of application, the invention will be more particularly described with reference to tires for vehicles of dumper type having an axial width greater than 37 inches.

The reinforcement armature or reinforcement of the tires and in particular of the tires for construction machinery is currently—and most frequently—formed by stacking one or more plies conventionally referred to as “carcass plies”, “crown plies”, etc. This manner of designating the reinforcement armatures is derived from the manufacturing process, which consists of producing a series of semi-finished products in the form of plies, provided with cord reinforcing threads which are frequently longitudinal, which plies are then assembled or stacked in order to build a tire blank. The plies are produced flat, with large dimensions, and are subsequently cut according to the dimensions of a given product. The plies are also assembled, in a first phase, substantially flat. The blank thus produced is then shaped to adopt the toroidal profile typical of tires. The semi-finished products referred to as “finishing” products are then applied to the blank, to obtain a product ready to be vulcanized.

Such a “conventional” type of process involves, in particular for the phase of manufacture of the blank of the tire, the use of an anchoring element (generally a bead wire), used for anchoring or holding the carcass reinforcement in the zone of the beads of the tire. Thus, in this type of process, a portion of all the plies constituting the carcass reinforcement (or of only a part thereof) is turned up around a bead wire arranged in the bead of the tire. In this manner, the carcass reinforcement is anchored in the bead.

The general adoption of this type of conventional process in the industry, despite the numerous different ways of producing the plies and assemblies, has led the person skilled in the art to use a vocabulary which reflects the process; hence the generally accepted terminology, comprising in particular the terms “plies”, “carcass”, “bead wire”, “shaping”, to designate the change from a flat profile to a toroidal profile, etc.

There are nowadays tires which do not, properly speaking, comprise “plies” or “bead wires” in accordance with the preceding definitions. For example, document EP 0 582 196 describes tires manufactured without the aid of semi-finished products in the form of plies. For example, the reinforcement elements of the different reinforcement structures are applied directly to the adjacent layers of rubber mixes, the whole being applied in successive layers to a toroidal core the form of which makes it possible to obtain directly a profile similar to the final profile of the tire being manufactured. Thus, in this case, there are no longer any “semi-finished products”, nor “plies”, nor “bead wires”. The base products, such as the rubber mixes and the reinforcement elements in the form of cords or filaments, are applied directly to the core. As this core is of toroidal form, the blank no longer needs to be shaped in order to change from a flat profile to a profile in the form of a torus.

Furthermore, the tires described in this document do not have the “conventional” upturn of the carcass ply around a bead wire. This type of anchoring is replaced by an arrangement in which circumferential cords are arranged adjacent to said sidewall reinforcement structure, the whole being embedded in an anchoring or bonding rubber mix.

There are also processes for assembly on a toroidal core using semi-finished products specially adapted for quick, effective and simple laying on a central core. Finally, it is also possible to use a mixture comprising at the same time certain semi-finished products to produce certain architectural aspects (such as plies, bead wires, etc.), whereas others are produced from the direct application of mixes and/or reinforcement elements.

In the present document, in order to take into account recent technological developments both in the field of manufacture and in the design of products, the conventional terms such as “plies”, “bead wires”, etc., are advantageously replaced by neutral terms or terms which are independent of the type of process used. Thus, the term “carcass-type reinforcing thread” or “sidewall reinforcing thread” is valid as a designation for the reinforcement elements of a carcass ply in the conventional process, and the corresponding reinforcement elements, generally applied at the level of the sidewalls, of a tire produced in accordance with a process without semi-finished products. The term “anchoring zone”, for its part, may equally well designate the “traditional” upturn of a carcass ply around a bead wire of a conventional process and the assembly formed by the circumferential reinforcement elements, the rubber mix and the adjacent sidewall reinforcement portions of a bottom zone produced with a process using application on a toroidal core.

With regard to the usual design of tires for construction machinery, the carcass reinforcement, anchored within each bead, is composed of at least one layer of metallic reinforcement elements, said elements being substantially parallel to each other in the layer and possibly being substantially radial. The carcass reinforcement is usually surmounted by a crown reinforcement composed of at least two working crown layers of metallic reinforcement elements, but which are crossed from one layer to the next, forming angles of between 10 and 65° with the circumferential direction. The crown reinforcement is itself surmounted by a tread.

“Axial” is understood to mean a direction parallel to the axis of rotation of the tire, and “radial” a direction intersecting the axis of rotation of the tire and perpendicular thereto. The axis of rotation of the tire is the axis around which it rotates in normal use.

A circumferential plane or circumferential section plane is a plane perpendicular to the axis of rotation of the tire. The equatorial plane or circumferential median plane is the circumferential plane which passes through the centre or apex of the tread and which divides the tire into two halves.

A radial plane is a plane containing the axis of rotation of the tire.

The longitudinal direction of the tire, or circumferential direction, is the direction corresponding to the periphery of the tire and defined by the direction of travel of the tire.

Tires for construction machinery, such as described above, are usually subject to a pressure of between 6 and 10 bar for usual loads and dimensions.

The carcass of radial tires, and more particularly with regard to tires of very large dimensions, is subject to great radial deformations resulting in major flexion, in particular due to the load borne by the tire.

In the case of vehicles, in particular those intended for use in mines or quarries for transporting loads, the difficulties of access and the demands of production are leading manufacturers of these vehicles to increase their loading capacity. It follows that the vehicles are becoming larger and larger and therefore themselves are becoming heavier and heavier and can transport greater and greater loads. The current weights of these vehicles may be as much as several hundreds tonnes, and the same applies to the load to be transported; the overall weight may be as much as 600 tonnes.

As the loading capacity of the vehicle is directly linked to that of the tires, it is known that in order to increase this loading capacity it is necessary to increase the amount of air contained in the tires.

Since current demand is aimed at increasing the loading capacity of these items of machinery, the different parameters listed previously have resulted in the tires becoming wider so as to increase the volume of air contained therein. It is in fact virtually impossible to increase the diameter of tires which has been reached nowadays, which is of the order of 4 meters, in particular for reasons of transporting said tires. This is because the dimensions of these tires will be limited for transportation, in particular by the road widths and by the clearance heights under bridges.

The dimensions of such tires, associated with the loads which they support during travel, result in deflections of the tires of the order of 30%; they may in particular be subjected to increases of load of greater than 50% due to dynamic overloads linked for example to braking for vehicles of loader type or alternatively for example to deformation of the travel tracks in the case of vehicles of dumper type.

The deflection of a tire is defined by the radial deformation of the tire, or variation in the radial height, when it changes from a non-loaded state to a statically loaded state, under rated load and pressure conditions.

It is expressed in the form of a relative deflection, defined by the ratio of this variation in the radial height of the tire to half the difference between the external diameter of the tire and the maximum diameter of the rim measured on the hook. The external diameter of the tire is measured statically in a non-loaded state at the rated pressure.

These deflections result in the bottom part of the sidewalls bearing on the rim hooks in the zone of the area of contact of the tire with the ground.

The tire is thus subjected to radial stresses in this zone. These are combined with longitudinal stresses in particular due to the deradialization of the tire in the zone of the area of contact. The combination of these stresses results in particular in the tire rubbing on the rim hooks.

These stresses to which the tires are subjected thus create cracks in the rubber mixes, which cracks spread through said mixes and adversely affect the endurance of the tire. These stresses also result in premature wear of the rubber mixes in contact with the rim hooks. Finally, owing to these stresses breaking of the reinforcement elements of the carcass-type layer and in particular of the upturn thereof in the case of a carcass ply turned up around a bead wire may occur.

For relatively small dimensions, an improvement in the endurance and/or the wear resistance of the tire can be obtained by using rubber mixes of greater thickness either to delay wear in particular due to rubbing or to provide greater rigidity of the sidewalls of the tire so as to limit the radial deformations. It would appear on the other hand that for dimensions of tires having an external diameter greater than 3.5 meters these solutions are not sufficient, the increase in the thickness of the sidewalls being limited by the very design of the tire/rim assemblies.

Furthermore, patent application WO 00/71365 described a technique making it possible to simplify the mounting of tires, these being mounted directly on the hub, which then acts as a rim. Independent rings then act as the rim seats and are held in place by locking rings which are integrally connected to the hub by means in particular of complementary profiles.

In their research and in particular during research into the production of a mounted assembly comprising tires of large dimensions, in particular of an axial width of greater than 37 inches, the inventors thus set themselves the task of improving the endurance and the wear resistance of the tires in particular under the action of the radial and longitudinal stresses described above to which the tire is subjected.

This object has been achieved according to the invention by a mounted assembly for heavy machinery, inflated to its rated pressure, constituted of a rim and a tire, the tire comprising a radial carcass reinforcement anchored to two beads and surmounted by a crown reinforcement which itself is surmounted by a tread joined to the beads by sidewalls and the rim being provided with two seats extended by rim hooks and intended to receive the beads of the tire, at least one device external to the tire and to the rim coming to bear, applying a pressure to at least one annular part of a sidewall, said device simultaneously bearing on a rim hook, the device being of toroidal form and defining an inner cavity.

In the spirit of the invention, a device of toroidal form means a device similar to a tire, that is to say a device defined by any section which generates the surface of the device by rotation about an axis located in the plane of said section and not passing through its centre.

This toroidal form must also be understood in the spirit of the invention as including a surface having a periodic variation in its section, that is to say a surface formed by repeating an elementary motif of said surface. This is in particular a motif imparting an undulation of the surface of the device.

In the spirit of the invention, the term “rim” covers the rim of a wheel, whether it be of monobloc type or consisting of several parts, and also the case of a rim constituted by part of a hub associated with a plurality of rings such as are described in document WO 00/71365.

The mounted assembly thus described comprising a device inserted between that part of the tire which usually comes to bear on the rim hook and said rim hook and said device which comes to bear, exerting a pressure on the tire, makes it possible to limit the radial deformations or flexions of the sidewalls of the tire.

According to one preferred variant embodiment of the invention, under rated conditions of load, the deflection of the tires in the zone of contact with the ground is less than 30%.

According to a preferred embodiment of the invention, the mounted assembly comprises two similar devices each associated with one of the rim hooks in order in particular to ensure symmetry of the deformation of the tire.

Furthermore, the device, advantageously selected with a low longitudinal rigidity, inserted between the rim hook and the sidewall of the tire, makes it possible to absorb at least some of the longitudinal stresses which are in particular due to the deradialization of the tire on entering and leaving the zone of the area of contact of the tire on the ground. This effect is reinforced still further in the case of a surface having a periodic variation of its section such as an undulation of said surface, the device then virtually no longer having any longitudinal rigidity.

According to one advantageous embodiment of the mounted assembly according to the invention, said assembly being subjected to rated load conditions, the cross-section of the device vanes over its periphery. This variation of the cross-section is therefore a function of the peripheral position and of the load borne by the mounted assembly. According to this embodiment of the invention, the device combines a function of limiting flexion and a function of bearing the sidewalls, further improving the endurance of the tire.

More advantageously still according to the invention, the device consists of at least one layer of polymer which imparts in particular the longitudinal deformation absorbing the deformations of the tire which are due to its deradialization.

In the case of large-sized vehicles intended for transporting heavy loads such as dumpers, the device is preferably formed of at least one layer of polymer comprising reinforcement elements, and the reinforcement elements are preferably arranged in a radial orientation. The radial orientation of the reinforcement elements, in particular in the presence of no other type of reinforcement elements, makes it possible in particular to maintain the low longitudinal rigidity of the device and therefore the possibility of best compensating for the phenomena of deradialization of the tire in the zone of the area of contact. Variant embodiments also provide for the presence of reinforcement elements in part only of the polymer layer.

According to such an embodiment, the device may advantageously be produced by a manufacturing process similar to that for a tire and more exactly for example by curing and/or vulcanizing a complex combining a rubber mix and reinforcement elements in a mould. The device may for example be likened to a simple carcass-type structure.

The reinforcement elements of this structure will advantageously be anchored in each of the ends of the structure by association with circumferential reinforcement elements arranged adjacent to said reinforcement elements of the structure. This type of assembly was presented previously in the introduction in the reference to the tires.

According to the types of variant embodiments of the invention which will be developed further, the device may be a tire of open toroidal form or alternatively a tire of closed toroidal form; the closure may for example be obtained after curing by bringing the free ends together, then by hot or cold gluing using any type of technique known to the person skilled in the art. The device forming an open or closed tire defines an inner cavity.

According to a more particularly advantageous embodiment which makes it possible in particular to limit the risks of rapid wear of the device, the device has a surface of low coefficient of friction at least in its part which comes into contact with the tire.

This surface of low coefficient of friction can be obtained by selection of the material constituting the device and for example of the polymer mix in the case of a polymeric layer.

It can also be obtained by surface coating the device with a product of low coefficient of friction such as Teflon-based products.

The surface of low coefficient of friction may be obtained by producing a structured surface, for example when molding in the case of a polymeric layer, which makes it possible to contain a fluid lubricating substance which is gradually released by wear. Such a substance may be incorporated by any means known to the person skilled in the art over depths of between 1 and 4 millimeters.

According to one preferred embodiment of the mounted assembly according to the invention, the device extends at least as far as the heel of the tire. According to this embodiment, the device after inflation of the mounted assembly is mounted integrally therewith and totally blocked owing to the pressure which brings the bead of the tire against the rim hook by means of said device.

The device may also extend as far as the axially inner part of the bead of the tire. The device is then present beneath the bead.

It is likewise also possible to provide an end of the device which goes beyond the axially inner end of the bead, in particular to facilitate industrial production of the assembly consisting of the device and tire.

According to a first variant embodiment of the mounted assembly according to the invention, the device is of pneumatic type and said device is inflated to a pressure substantially equivalent to that of the tire and preferably equal to that of the tire.

According to this variant embodiment of the invention, the reaction of the device on the sidewall of the tire bearing on the rim hook makes it possible, as mentioned previously, to limit the deformation of the sidewall part in contact with the device in the zone of the area of contact and furthermore absorbs part of the surface deformation of the tire due to the deradialization of said tire in the zone of the area of contact owing to its deformation and its low longitudinal rigidity.

According to this variant embodiment of the invention, the device of pneumatic type forms at least one cavity advantageously defined internally by a layer of an airtight material, such as a layer of butyl.

The device may advantageously comprise several longitudinal cavities; such an embodiment makes it possible in particular to maintain the function of the device if one of the cavities is accidentally degraded.

When the device is kept at a pressure equal to that of the tire, it would appear that the sidewall in the zone of contact with the device where it is subjected to identical pressures on either side retains its natural line of inflation. The result is that the zone of deformation of the sidewall, when the tire is under load, having the greatest axial width is offset radially towards the crown of the tire compared with a tire subjected to the same load and not comprising the device according to the invention. It would appear furthermore that the greatest axial width of deformation is greater than that of a tire which does not comprise the device according to the invention.

According to one embodiment of the invention, the device according to the invention is pressurized by any means known to the person skilled in the art.

According to one preferred embodiment of the invention, the device is joined to the cavity of the tire. Such an embodiment makes it possible to ensure identical pressures. In the case of a plurality of longitudinal cavities, each of them is advantageously joined to the cavity of the tire.

When, as mentioned previously, provision is made for the device to extend as far as the heel of the tire, means such as grooves beneath the bead of the tire are advantageously provided to permit passage of the air from the cavity of the tire to the device according to the invention. According to such an embodiment, unlike a conventional mounted assembly, airtightness is no longer produced between the rim seat and the bead of the tire, but on one hand between the device and the rim hook with which it is in contact and between the device and the bead and/or the sidewall of the tire on the other hand.

When the device, as also mentioned previously, extends as far as the axially inner part of the bead of the tire, said device advantageously comprises a system for draining the air, said system being at least present beneath the bead of the tire.

When the device extends as far as the axially inner part of the bead of the tire, the invention also advantageously provides for that part of the device which comes under the bead of the tire and in contact with the seat of the rim to comprise circumferentially oriented reinforcement elements to improve the distribution of the pressures on the seat of the rim.

According to one or the other of these embodiments, provision is advantageously made for the intake of air into the device according to the invention to take place by a capillary-type system so as to limit the flow rate thereof. Such a system will result in inflation times for the device according to the invention which are increased but will have the advantage of being able in the reverse direction to increase the deflation time of the mounted assembly in the event of degradation or puncturing of the device according to the invention. Such an embodiment may in particular allow the vehicle to return to a repair zone in the event of an accident.

The intake of air into the device according to the invention can also be advantageously obtained by a system of high flow rate comprising a blocking device actuated by a difference in pressure between the device and the cavity of the tire. The blocking device can for example be actuated by a system of valve and springs or any other means known to the person skilled in the art. Unlike the previous solution, the inflation times of the device are not then increased and in the event of degradation of the device the pressure of the tire is not adversely affected.

As in the case of the outer surface of the device, the invention advantageously provides, according to this first variant embodiment, for the walls of the internal cavities of the device to have surfaces of low coefficient of friction. Such an embodiment may make it possible to limit the risks of degradation for example in cases of use in overloaded state which may result in contacts within the cavity (cavities).

According to a second variant embodiment of the mounted assembly according to the invention, the device forms at least one cavity filled by an incompressible product.

According to this second variant embodiment, and as in the case of the previous variant embodiment of the invention, the reaction of the device on the sidewall of the tire bearing on the rim hook makes it possible to limit the deformation of the sidewall part in contact with the device in the zone of the area of contact and furthermore to compensate for the deradialization of the tire in the zone of the area of contact owing to its deformation and its low longitudinal rigidity. The appropriate deformation of the device according to the invention making it possible to limit the deformation of the sidewall part of the tire is obtained by selecting the volume of the product introduced into the device; the selection of this volume combined with the inflation of the tire and its use results in the desired pressure resultant which is exerted on part of the sidewall of the tire.

The incompressible product according to this variant embodiment may be any type of fluid such as water or oil. The device then forms at least one cavity limited advantageously internally by a layer of material which is stable with respect to the fluid such as nitrites or polyurethane.

According to one advantageous embodiment, the dynamic viscosity of the incompressible product is greater than 10 poise.

In comparison with the variant embodiment with a fluid of low dynamic viscosity, the embodiment of this type of device according to the invention, owing to the selection of the viscosity of the product, makes it possible to obtain longitudinal propagation of the deformation of the device which is slower during the rotation of the tire in use and thus to impart a dampening effect.

The incompressible product according to this variant embodiment may be any product known to the person skilled in the art such as oils, silicone gels or polyurethane.

It may also be an electrorheological fluid controlled by measurements of flow rate at several points on the periphery in the cavity and activated by conductive walls. The difference in flow rate between several points, at least one of which is located in the zone of the area of contact, determines the operations of controlling the fluid.

According to this second variant embodiment in which the device forms at least one cavity filled by an incompressible product, said incompressible product may also be a cross-linked polymer preferably having an amount of penetration of between 50 and 500 tenths of a millimetre, the measurement being effected by penetrometry in accordance with Standard ASTM D217. More preferably still, the cross-linked polymer has a Shore hardness of less than 20; it is for example a silicone gel.

The selection of such a cross-linked polymer imparts properties of deformation and stability which ensure in particular in accordance with the invention a function of limiting the flexion and a function of supporting the sidewalls and also makes it possible to absorb at least some of the longitudinal stresses in particular due to the deradialisation of the tire; furthermore, the choice of such a cross-linked polymer may permit operation of the device in the event of partial degradation of said device.

According to a third variant embodiment of the mounted assembly according to the invention, the device forms a cavity comprising at least one annular pocket filled with an incompressible product, and an elastic annular zone.

According to this third variant embodiment of the invention, and as in the case of the previous variant embodiments of the invention, the reaction of the device on the sidewall of the tire bearing on the rim hook makes it possible to limit the deformation of the sidewall part in contact with the device in the zone of the area of contact and furthermore compensates for the deradialization of the tire in the zone of the area of contact owing to its deformation and its low longitudinal rigidity. Unlike the previous cases comprising a cavity enclosing an incompressible product, according to this variant embodiment the elastic axial deformation of the device permits limitation of the deformation of the sidewalls of the tire, independently of the volume of the product.

One preferred embodiment of this third variant embodiment of the invention provides for the device to form a cavity comprising at least two annular pockets each filled with an incompressible product, said two annular pockets being separated by an elastic annular zone.

According to any one of these variant embodiments of a mounted assembly according to the invention which have been previously described, the device is divided into compartments in the circumferential direction to form a series of circumferentially contiguous cells.

According to this type of embodiment of the invention, the device comprises cells or compartments which are separated from each other by partitions preferably made of polymeric material in the case of a device made of polymer. Such an embodiment also makes it possible to limit the risks of immobilization of a vehicle in the event of degradation of the device according to the invention, since such degradation will be localized on a limited number of cells but will not adversely affect the whole of the device. It may also make it possible to continue to run normally since only isolated cells are degraded, the device no longer being as effective but even so providing an advantage in terms of endurance.

More preferably still according to this type of embodiment of the device according to the invention, two contiguous cells communicate with one another. An appropriate selection of the diameter of the means permitting communication or alternatively selection of products of high dynamic viscosity will make it possible to create a dampening function of the device.

According to another embodiment of the invention, whatever the variant embodiment of the device according to the invention the device is circumferentially discontinuous, forming elementary structures.

According to this embodiment, the device is formed by a set of elementary structures which are independent of one another and separated from each other in the circumferential direction. Such an embodiment of the device according to the invention imparts thereto a virtually non-existent circumferential rigidity.

More advantageously still according to the latter type of embodiment, the elementary structures are linked to one another to form a unitary device of toroidal form, the handling and positioning of which will be simplified compared with elementary structures independent of one another.

According to any one of these variant embodiments of the mounted assembly according to the invention, the tests performed have shown that the performance of the tire in terms of endurance and wear at the level of the join zone between the sidewalls and the beads is improved. It would appear in particular that the problems of wear of the tire by friction at the level of the rim hooks were overcome. It also emerges that the problems of endurance due to shearing in the rubber mixes are greatly reduced. It also appeared that the problems linked to the compression of upturns of carcass ply are reduced.

To improve still further this latter point relating to the upturns of carcass ply, the invention advantageously proposes limiting the height of said upturns to the contact zone between the sidewall and the device according to the invention.

The device according to the invention, which is external to the tire and to the rim, may be proposed as an independent element inserted during mounting of the mounted assembly.

The invention also provides variant embodiments according to which the device is linked beforehand to a rim hook, in particular in the case of wheels consisting of several parts as is usually the case for large-dimension tires for construction machinery or alternatively in the case of the technique as described in document WO 00/71365.

In the same context as the previous variant, the device according to the invention may be made integral with a rim hook prior to mounting of the tire.

It is also possible according to the invention to provide a tire associated, prior to its mounting on a rim, with at least one device according to the invention, as described previously, by any means known to the person skilled in the art such as hot or cold gluing.

The invention thus also proposes a tire for heavy machinery, comprising a radial carcass reinforcement anchored to two beads, surmounted by a crown reinforcement, which itself is surmounted by a tread joined to the beads by sidewalls, at least one external device integral with the tire coming to bear on at least part of a sidewall and said device being of toroidal type.

The invention also proposes a process of limiting the flexion of the sidewalls of a tire, comprising a radial carcass reinforcement anchored to two beads, surmounted by a crown reinforcement, which is itself surmounted by a tread joined to the beads by sidewalls, forming a mounted assembly for heavy machinery by association with a rim, which is provided with two seats extended by hooks and intended to receive the beads of the tire, at least one device external to the tire and to the rim applying a pressure equivalent to the inflation pressure over at least part of a sidewall, furthermore bearing on a rim hook.

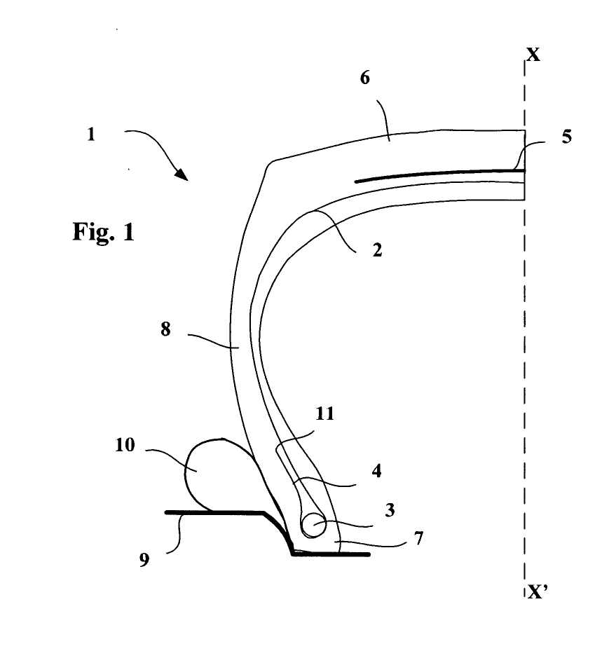

Other advantageous details and characteristics of the invention will become apparent hereafter from the description of examples of embodiment of the invention with reference to FIGS. 1 to 4, which represent:

FIG. 1: a diagram viewed in radial section of a construction-vehicle tire according to the invention,

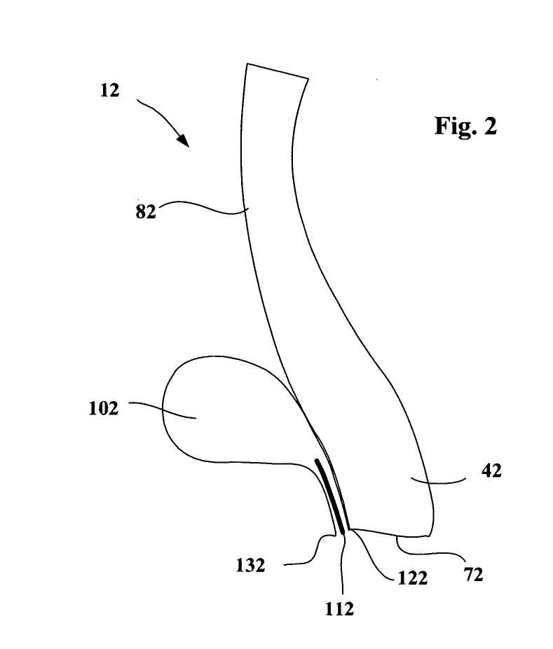

FIG. 2: a diagrammatic representation viewed in radial section of a first embodiment of the invention,

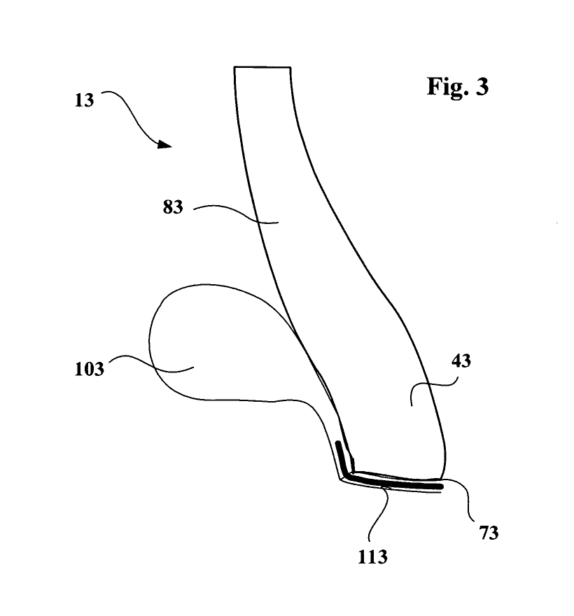

FIG. 3: a diagrammatic representation viewed in radial section of a second embodiment of the invention,

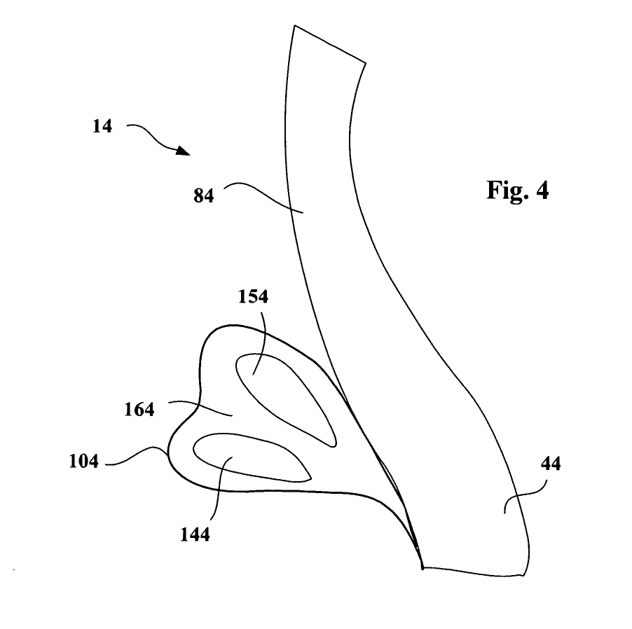

FIG. 4: a diagrammatic representation viewed in radial section of a third embodiment of the invention.

The figures are not shown to scale in order to simplify understanding thereof. The figures show only half of the architectures which extend symmetrically to the axis XX′, which represents the circumferential median plane of a tire.

FIG. 1 diagrammatically represents a radial section through a tire 1 usually used for construction machinery.

This tire 1 is a large-dimension tire the form ratio H/S of which is 0.80, H being the height of the tire on its rim and S the maximum axial width of the tire, when the latter is mounted on its operating rim and inflated to its recommended pressure.

This tire 1 comprises a carcass reinforcement 2 composed of a ply of inextensible metal cables made of steel, which is anchored within each bead to a bead wire 3 to form an upturn 4. The carcass reinforcement 2 is surmounted radially by a crown reinforcement 5. Said crown reinforcement 5 is usually formed on one hand of two plies, referred to as “working” plies, and on the other hand of two protective plies. The working plies are themselves formed of inextensible cables made of steel, which are parallel to each other within each ply and crossed from one ply to the next, forming angles which may be of between 15° and 45° with the circumferential direction. The protective plies are generally formed of elastic metal cables made of steel, which are parallel to each other within each ply and crossed from one ply to the next, also forming angles which may be of between 15° and 45°. The cables of the radially outer working ply are usually crossed with the cables of the radially inner protective ply. The details of the crown reinforcement are not shown in the drawings. The crown reinforcement is finally surmounted by a tread 6 which is joined to the two beads 7 by the two sidewalls 8.

The tire is shown mounted on a rim hook 9 the axial width of which is greater than the usual width of wheel rim hooks intended for this type of application. The invention also advantageously provides a rim hook the axially outer diameter of which is less than the maximum diameter of said hook; in other words, the rim hook may advantageously be produced with a slope relative to the axial direction, the slope being directed towards the axis of rotation when facing axially towards the outside. Such an embodiment makes it possible to produce a device the dimension of which in a radial orientation is greater, which makes it possible to produce a device with a lesser longitudinal rigidity. Such an embodiment is not depicted in the drawings.

In accordance with the invention, a device 10 of toroidal form is interposed between the bottom of the sidewall 8 and the hook 9 of the rim. The device 10 is formed of a polymer layer comprising radially oriented reinforcement elements. The device 10 interposed between the bottom zone of the sidewall 8 and the rim hook 9 makes it possible to limit the flexions of the sidewalls of the tire as the wheel turns in the zone of the area of contact.

Furthermore, the radial orientation of the reinforcement elements imparts to the device a low longitudinal rigidity and hence the possibility of compensating at least in part for the phenomena of deradialization of the tire in the zone of the area of contact.

As mentioned previously, the reduction in the stresses which the tire withstands owing to these deformations makes it possible to improve substantially the performance of the tire in terms of endurance and wear. The problems linked to the compression of the upturns of carcass ply are also reduced. To improve still further this latter point, the end 11 of the upturn 4 of the carcass reinforcement is limited to the zone of contact between the sidewall 8 and the device 10 according to the invention.

In FIG. 2 there is shown diagrammatically in radial section an enlarged view of an example of embodiment of a device 10 in accordance with FIG. 1. In this FIG. 2, only the bead 42 of the tire and the device 102 are depicted. In this FIG. 2 the device 102 is integral with the tire 12 and fixed to the bottom part of the sidewall 82.

According to this representation of FIG. 2, the device 102 may be of pneumatic type and is inflated to a pressure substantially equivalent to that of the tire. One preferred embodiment of the invention provides for the pressure to be identical to that of the tire; the internal volume of the device 102 is then advantageously linked to that of the tire. For this, a wick 112 is held between the two ends 122, 132 of the device 102. Using the wick 112 will delay the inflation of the device 102 but will make it possible in the event of an incident to delay deflation of the tire and thus to enable the vehicle to return for repair. The tire then comprises, beneath the lower surface 72 of the bead, elements in relief, not shown in the figure, to enable air to pass from the tire towards the device 102 when the tire is mounted on the seats of a rim.

According to this representation of FIG. 2, the device 102 forms a cavity which may be filled by an incompressible product the dynamic viscosity of which is advantageously greater than 10 poise in order to impart a dampening function. It may for example be a silicone gel. The dampening function of the device according to the invention is more particularly advantageous in the case of vehicles of loader type which have a natural tendency to cause oscillation of the vehicle since it is moving with a loaded scoop. The device can then make it possible to mitigate this phenomenon of oscillations.

FIG. 3 is a diagrammatic representation viewed in radial section of another example of embodiment of the invention. This embodiment differs from that of FIG. 2 by the fact that the device 103 is extended as far as the axially inner end 73 of the bead of the tire. The device 103 also comprises a wick 113, present at least beneath the bead 43 of the tire.

According to one or the other of these embodiments linked to FIGS. 2 and 3, the reaction of the device 10, 102, 103 on the sidewall of the tire 1, 12, 13 bearing on the rim hook 9 makes it possible to limit the deformation of that part of the sidewall in contact with the device in the zone of the area of contact.

The device 10, 102, 103 furthermore makes it possible to absorb part of the deformation of the tire due to the deradialization of the tire in the zone of the area of contact owing to the low longitudinal rigidity of the device 10, 102, 103.

In the case of an incompressible product, the appropriate deformation of the device according to the invention making it possible to limit the deformation of the sidewall part of the tire is obtained by selecting the volume of the product which defines the pressure exerted by the device on the sidewall of the tire to limit the deformation of the sidewalls thereof.

Selecting a product of high dynamic viscosity furthermore makes it possible to ensure a dampening function as mentioned previously.

FIG. 4 is a diagrammatic representation viewed in radial section of a third embodiment of the invention. In this FIG. 4, the device 104 forms a cavity comprising two annular pockets 144, 154 each filled with an incompressible product, said two annular pockets being separated by an elastic annular zone 164. According to this embodiment of the invention, the elastic deformation of the device 104 when the tire is pressurized makes it possible to obtain the desired reaction pressure of the device on the sidewall, independently of the volume of the product.

Just as in the previous cases, selection of a product of high dynamic viscosity makes it possible to provide a dampening function such as described previously.

1. A mounted assembly for heavy machinery, inflated to its rated pressure, formed of a rim and a tire, the tire comprising a radial carcass reinforcement anchored to two beads, surmounted by a crown reinforcement which itself is surmounted by a tread joined to the beads by sidewalls, the rim being provided with two seats extended by rim hooks and intended to receive the beads of the tire, wherein at least one device external to the tire and to the rim comes to bear, applying a pressure, on at least one annular part of a sidewall, wherein said device simultaneously bears on a rim hook, wherein the device is of toroidal form and wherein the device defines an inner cavity.

2. A mounted assembly according to claim 1, subjected to conditions of rated load, wherein the cross-section of the device varies over its periphery.

3. A mounted assembly according to claim 1, wherein the device is formed of at least one polymer layer.

4. A mounted assembly according to claim 3, wherein the device comprises reinforcement elements and wherein said reinforcement elements are arranged in a radial orientation.

5. A mounted assembly according to claim 1, wherein the device extends at least as far as the heel of the tire.

6. A mounted assembly according to claim 1, wherein the device extends as far as the axially inner part of the bead of the tire.

7. A mounted assembly according to claim 1, wherein the device is of pneumatic type and wherein it is inflated to a pressure substantially equivalent to that of the tire and preferably equal to that of the tire.

8. A mounted assembly according to claim 7, wherein the device is joined to the cavity of the tire by a capillary conducting air.

9. A mounted assembly according to claim 7, wherein the device is joined to the cavity of the tire by a system of high flow rate comprising a blocking device actuated by a difference in pressure between the device and the cavity of the tire.

10. A mounted assembly according to claim 1, wherein the device forms a cavity filled by an incompressible product.

11. A mounted assembly according to claim 1, wherein the device forms a cavity comprising at least one annular pocket filled with an incompressible product and an elastic annular zone.

12. A mounted assembly according to claim 11, wherein the device forms a cavity comprising at least two annular pockets each filled with an incompressible product and wherein the two annular pockets are separated by an elastic annular zone.

13. A mounted assembly according to claim 10, wherein the dynamic viscosity of the product is greater than 10 poise.

14. A mounted assembly according to claim 10, wherein the incompressible product is a cross-linked polymer and, wherein the product has an amount of penetration of between 50 and 500 tenths of a millimeter.

15. A mounted assembly according to claim 1, wherein the device is divided into compartments in the circumferential direction to form a series of circumferentially contiguous cells.

16. A mounted assembly according to claim 15, wherein two contiguous cells communicate with one another.

17. A mounted assembly according to claim 1, wherein the device is circumferentially discontinuous, forming elementary structures.

18. A mounted assembly according to claim 17, wherein the elementary structures are linked to one another to form a unitary assembly of toroidal form.

19. A process for limiting the flexion of the sidewalls of a tire, comprising a radial carcass reinforcement anchored to two beads, surmounted by a crown reinforcement, which is itself surmounted by a tread joined to the beads by sidewalls, forming a mounted assembly for heavy machinery by association with a rim, which is provided with two seats extended by hooks and intended to receive the beads of the tire, wherein at least one device external to the tire and to the rim applies a pressure equivalent to the inflation pressure over at least part of a sidewall, bearing on a rim hook.

20. A tire for heavy machinery, comprising a radial carcass reinforcement anchored to two beads, surmounted by a crown reinforcement, which itself is surmounted by a tread joined to the beads by sidewalls, wherein at least one external device integral with the tire comes to bear on at least one part of a sidewall and wherein the device is of toroidal type.

21. A tire according to claim 20, wherein the device is formed of at least one polymer layer.

22. A tire according to claim 21, wherein the device comprises reinforcement elements and wherein said reinforcement elements are arranged in a radial orientation.

23. A tire according to claim 20, wherein the device is fixed to the tire and wherein the device extends at least as far as the heel of the tire.

24. A tire according to claim 20, wherein the device is fixed to the tire and wherein the device extends as far as the axially inner part of the bead of the tire.

25. A tire according to claim 20, wherein the device is of pneumatic type.

26. A tire according to claim 20, wherein the device forms a cavity filled by an incompressible product.

27. A tire according to claim 20, wherein the device forms a cavity comprising at least one annular pocket filled with an incompressible product and an elastic annular zone.

28. A tire according to claim 27, wherein the device forms a cavity comprising at least two annular pockets each filled with an incompressible product and wherein the two annular pockets are separated by an elastic annular zone.

29. A tire according to claim 26, wherein the dynamic viscosity of the product is greater than 10 poise.

30. A tire according to claim 26, wherein the incompressible product is a cross-linked polymer and, preferably, wherein the product has an amount of penetration of between 50 and 500 tenths of a millimeter.

31. A mounted assembly according to claim 11, wherein the dynamic viscosity of the product is greater than 10 poise.

32. A mounted assembly according to claim 11, wherein the incompressible product is a cross-linked polymer and, wherein the product has an amount of penetration of between 50 and 500 tenths of a millimeter.

33. A tire according to claim 27, wherein the dynamic viscosity of the product is greater than 10 poise.

34. A tire according to claim 27, wherein the incompressible product is a cross-linked polymer and, preferably, wherein the product has an amount of penetration of between 50 and 500 tenths of a millimeter.
